(19) United States
(12) Patent Application Publication
(10) Pub. No.: US 2012/0069544 A1
(43) Pub. Date: Mar. 22, 2012

(54) LIGHT-EMITTING DEVICE WITH A LUMINESCENT MEDIUM, CORRESPONDING LIGHTING SYSTEM COMPRISING THE LIGHT-EMITTING DEVICE AND CORRESPONDING LUMINESCENT MEDIUM

(75) Inventors: Thomas Juestel, Witten (DE); Ulrich Weichmann, Aachen (DE); Joachim Opitz, Aachen (DE); Cornelis Reinder Ronda, Aachen (DE)

(73) Assignee: KONINKLIJKE PHILIPS ELECTRONICS N.V., EINDHOVEN (NL)

(21) Appl. No.: 13/258,510

(22) PCT Filed: Mar. 16, 2010
(86) PCT No.: PCT/IB10/51124

§ 371 Date: Dec. 7, 2011

(30) Foreign Application Priority Data
Mar. 23, 2009 (EP) 09155914.6

(51) Int. Cl. F21V 9/16; C09K 11/78; C09K 11/80; C09K 11/84; C09K 11/79

(52) U.S. Cl. 362/84; 252/301.4 S; 252/301.4 F; 252/301.4 R

(57) ABSTRACT

The invention relates to a light emitting device (1) with high colour rendering comprising a wavelength converting member (2) with a luminescent medium for wavelength conversion of blue light and/or ultraviolet light (10) into red light and/or yellow and/or green light and a light source (3) emitting blue light (10) and/or ultraviolet light arranged to pump the luminescent medium, said luminescent medium essentially having a main phase of a solid state host material which is doped with Ce³⁺-ions. According to the invention the host material comprises ions of a further rare-earth material Ln, wherein the host material is selected such that the emission energy of the 5d-4f emission on Ce³⁺-ions is energetically higher than the absorption energy into an upper 4fⁿ state of the further rare-earth material Ln, and wherein the light emission of wavelength converted light is caused by an intra-atomic 4fⁿ-4fⁿ transition within the ions of the further rare-earth material.

The invention further relates to a corresponding lighting system comprising the light-emitting device and a corresponding luminescent medium.

### FIELD OF THE INVENTION

The present invention relates to a light-emitting device, especially to the field of LEDs, comprising a wavelength converting member with a luminescent medium for wavelength conversion (color conversion) of blue light and/or ultraviolet light into red light and/or yellow light and/or green light and a light source emitting blue light and/or ultraviolet light arranged to pump the luminescent medium, said luminescent medium essentially having a main phase of a solid state host material which is doped with Ce³⁺-ions. The present invention further relates to a corresponding lighting system comprising at least one light emitting device and the corresponding luminescent medium.

### BACKGROUND OF THE INVENTION

A light-emitting device comprising a light source and a wavelength converting member with a luminescent medium for wavelength conversion is known for example as a light-emitting device comprising a Light Emitting Diode (LED) emitting blue light and/or ultraviolet light and a wavelength converting member comprising a phosphor medium in the optical path of the LED for partially converting blue and/or ultraviolet light into yellow and/or green light to generate white light. Said luminescent medium has a main phase of a Ce³⁺-ions doped sulfide, especially from the group of (Mg, Ca,Sr)S, or a Ce³⁺-ions doped garnet like Y₃Al₅O₁₂:Ce (YAG) or (Gd₁₋ₓYₓ)₃(Al_{1-y}Ga_{y})₅O₁₂:Ce (YAGaG:Ce).

Further on light-emitting devices formed as “red-enhanced LEDs” based on additional Eu²⁺ wideband emitters with high colour rendering but low luminance are known.

### SUMMARY OF THE INVENTION

It is an object of the present invention to provide light emitting device with an enhanced lumen yield and improved colour rendering.

This object is achieved with the light emitting device with high colour rendering according to claim 1.

The host material comprises ions of a further rare-earth material (Ln: lanthanide), wherein the host material is selected such that the emission energy of the 5d-4f emission on Ce³⁺-ions is energetically higher than the absorption energy into an upper 4fⁿ state of the further rare-earth material Ln, and wherein the light emission of wavelength converted light is caused by an intra-atomic 4fⁿ-4fⁿ transition within the ions of the further rare-earth material. The Ce³⁺-ions work as a sensitizer of the further ions of the rare earth material which function as activators, whereby the host material is selected in a way that the (emission) energy difference involving the Ce³⁺ f¹ ground state and the lowest relaxed excited 5d state is larger than the energy difference between the ground- and excited 4f excited states, involved in the emission process, of the Ln³⁺ ion, to which the energy is transferred. The light-emitting device comprises a wavelength converting member with a luminescent medium for wavelength conversion (color conversion) of blue light and/or ultraviolet light into yellow light and/or green light and/or red light, said luminescent medium essentially having a main phase of a solid state host material which is doped with Ce³⁺-ions. The pumping scheme involves 4f-5d-transitions in Ce³⁺-ions, and energy transfer to an upper 4fⁿ state of the trivalent ion of the further rare-earth material, from which additional luminescence emission takes place.

With respect to the present invention, the term “high colour rendering” relates to a light-emitting device with a colour rendering index (CRI) equal to or higher than 70 (CRI≧70).

The light source especially is a Light Emitting Diode (LED), a laser or a discharge lamp and the luminescent medium is a medium for converting the wavelength of one part of the blue and/or ultraviolet light into a red light component caused by the 4fⁿ-4fⁿ transition within the ions of the further rare-earth material and the yellow and/or green and/or red light caused by the main phase of the solid state host material to generate white light. The wavelength of the blue light and/or ultraviolet light is preferably in the spectral region of 300 nm to 480 nm.

A suitable luminescent medium can be found by preparing the Ce-doped solid state host material and measuring the excitation spectrum, the reflection spectrum and the emission spectrum of the resulting luminescent medium in the wavelength region from about 150 nm to about 700 nm.

With respect to the host material according to the invention the term “essentially” means especially that ≧95%, preferably ≧98% and most preferred ≧99.5% of the host material of the gain medium has the desired structure and/or composition.

The term “main phase” implies that there may be further phases, e.g. resulting out of mixture(s) of the above-mentioned materials with additives which may be added e.g. during ceramic processing. These additives may be incorporated fully or in part in the final material, which then may also be a composite of several chemically different species and particularly include such species known to the art as fluxes.

According to a preferred embodiment of the present invention, the further trivalent rare-earth ions are Pr³⁺, Sm³⁺, Tb³⁺, Dy³⁺ or a mixture thereof to design light-emitting devices emitting light of a different chromaticity, for example with an enhanced red-component of the emitted light. The pumping scheme includes the following steps:

a) Ce³⁺+hν→(Ce³⁺)*(4f-5d-optical absorption on Ce³⁺-ions);

b) (Ce³⁺)*+Ln³⁺→Ce³⁺+(Ln³⁺)*(energy transfer); and

c) (Ln³⁺)*→Ln³⁺+hν (luminescence on Ln³⁺ ions);

wherein the further trivalent rare-earth ions Ln³⁺ are Pr³⁺, Sm³⁺, Tb³⁺, Dy³⁺. The [Xe]4fⁿ-[Xe]4fⁿ transition causing the light emission of wavelength converted light is electric dipole forbidden (e.g. the ⁵D₄-⁷F₅ transition of Tb³⁺).

According to a preferred embodiment of the present invention, the luminescent medium has a dopant concentration of the Ce³⁺-ions in the range of 0.01% mol to 5% mol and a concentration of the further rare earth ions, which is between 0.5 and 50 times the dopant concentration of the Ce³⁺-ions.

According to another preferred embodiment of the present invention, the luminescent medium is selected from the following materials: (Lu_{1-a-b}CeₐLn_{b})₃(Al_{1-x-y}GaₓSc_{y})₅O₁₂ (0.0≦a≦0.1; 0.0≦b≦0.6; 0.0≦x≦0.5; 0.0≦y≦0.5). The luminescent medium preferably is (Lu_{1-a-b}CeₐTb_{b})₃AlGa₄O₁₂ with 0.0≦a≦0.1; 0.0≦b≦0.6.

According to another preferred embodiment of the present invention, the luminescent medium is selected from the following materials: Ca_{1-x-y-a-b}MgₐSr_{b}(Ce_{x/2}Ln_{y/2}Na_{(x+y)/2})S (0.0≦a<1.0; 0.0≦b<1.0; and a+b<1; 0.0≦x<0.05; 0.0≦y<0.05).

According to another preferred embodiment of the present invention, the luminescent medium is selected from the following materials: (Y_{1-x-a-b}GdₓCeₐLn_{b})₂SiO₅ (0.0≦a≦0.1; 0.0≦b≦0.1; 0.0≦x≦1.0 and 0.0≦y≦1.0).

According to another preferred embodiment of the present invention, the luminescent medium is selected from the following materials: (Y_{1-a-b}CeₐLn_{b})₃(Al_{1-x-y}GaₓSc_{y})₅O₁₂ (0.0≦a≦0.1; 0.0≦b≦0.1; 0.0≦x≦0.5; 0.0≦y≦0.5). The luminescent medium preferably is (Y_{1-a-b}CeₐTb_{b})₃AlGa₄O₁₂ with 0.0≦a≦0.1; 0.0≦b≦0.6.

According to another preferred embodiment of the present invention, the luminescent medium is selected from the following materials: Gd_{1-a-b}CeₐTb_{b}BO₃ (0.0≦a≦0.1; 0.0≦b≦0.6).

According to a preferred embodiment of the present invention, the luminescent medium is a powder or a ceramic or a monocrystalline material. The powder is used to form a wavelength converting member formed as a luminescent screen.

The composition of the luminescent medium formed as a powder and/or ceramic material comprises the following steps: dissolving a metal nitrate in water; inpissating of the resulting dissolution; calcination of the original mixture under CO-atmosphere at 900° C. to 1200° C.; milling and further calcination under CO-atmosphere at 1500° C. to 1700° C.; and braking/milling and sieving the powder, especially with a sieve having 36 microns openings. The resulting powder has an average particle size of about 5 microns (5 μm). The following step is used to produce ceramic material: The milled powders are dried and pressed and subsequently exposed to uniaxial or isostatic pressure to form ceramic compacts of the desired shape.

The present invention further relates to a lighting system comprising at least one aforementioned light emitting device, wherein the system is used in one or more of the following applications:
spot lighting systems,
fiber-optics application systems,
projection systems,
self-lit display systems,
pixelated display systems,
segmented display systems,
warning sign systems,
medical lighting application systems,
indicator sign systems,
portable systems
LED systems
radiation detectors and
automotive applications.

It is a further object of the present invention to provide a luminescent medium adapted for a light emitting device with an enhanced lumen yield and improved colour rendering.

This object is achieved with the luminescent medium according to claim 11. The luminescent medium for wavelength conversion of blue light and/or ultraviolet light into yellow light and/or green and/or red light essentially has a main phase of a solid state host material which is doped with Ce³⁺-ions and comprises ions of a further rare-earth material Ln, wherein the host material is selected such that the emission energy of the 5d-4f emission of Ce³⁺-ions is energetically higher than the absorption energy into an upper 4fⁿ state of the further rare-earth material.

According to a preferred embodiment of the present invention, the ions of the further rare-earth material Ln are Pr³⁺, Sm³⁺, Tb³⁺, Dy³⁺ or a mixture thereof.

According to a preferred embodiment of the present invention, the host material has a dopant concentration of the Ce³⁺-ions in the range of 0.01% mol to 5% mol and a concentration of the further rare earth ions, which is between 0.5 and 50 times the dopant concentration of the Ce³⁺-ions.

According to a preferred embodiment of the present invention, the luminescent medium is selected from the following materials: (Lu_{1-a-b}CeₐLn_{b})₃(Al_{1-x-y}GaₓSc_{y})₅O₁₂ (0.0≦a≦0.1; 0.0≦b≦0.6; 0.0≦x≦0.5; 0.0≦y≦0.5). The luminescent medium preferably is (Lu_{1-a-b}CeₐTb_{b})₃AlGa₄O₁₂ with 0.0≦a≦0.1; 0.0≦b≦0.6.

According to another preferred embodiment of the present invention, the luminescent medium is selected from the following materials: Ca_{1-x-y-a-b}MgₐSr_{b}(Ce_{x/2}Ln_{y/2}Na_{(x+y)/2})S (0.0≦a<1.0; 0.0≦b<1.0; and a+b<1; 0.0≦x<0.05; 0.0≦y<0.05).

According to another preferred embodiment of the present invention, the luminescent medium is selected from the following materials: (Y_{1-x-a-b}GdₓCeₐLn_{b})₂SiO₅(0.0≦a≦0.1; 0.0≦b≦0.1; 0.0≦x≦1.0 and 0.0≦y≦1.0).

According to another preferred embodiment of the present invention, the luminescent medium is selected from the following materials: (Y_{1-a-b}CeₐLn_{b})₃(Al_{1-x-y}GaₓSc_{y})₅O₁₂ (0.0≦a≦0.1; 0.0≦b≦0.6; 0.0≦x≦0.5; 0.0≦y≦). The luminescent medium preferably is (Y_{1-a-b}CeₐTb_{b})₃AlGa₄O₁₂ with 0.0≦a≦0.1; 0.0≦b≦0.6.

According to another preferred embodiment of the present invention, the luminescent medium is selected from the following materials: Gd_{1-a-b}CeₐTb_{b}BO₃ (0.0≦a≦0.1; 0.0≦b≦0.6).

The aforementioned components, as well as the claimed components and the components to be used in accordance with the invention in the described embodiments, are not subject to any special exceptions with respect to their size, shape, material selection and technical concept such that the selection criteria known in the pertinent field can be applied without limitations.

### BRIEF DESCRIPTION OF THE DRAWINGS

Additional details, features, characteristics and advantages of the object of the invention are disclosed in the subclaims, the figures and the following description of the respective figure and examples, which—in an exemplary fashion—show one embodiment and example of a light-emitting device according to the invention.

In the drawings:

FIG. 1 is a top view of an example of a light-emitting device according to one embodiment of the invention;

FIG. 2 shows an excitation scheme of a preferred embodiment of the luminescence medium;

FIG. 3 shows the emission, excitation and reflection spectrum of a preferred embodiment of the luminescence medium; and

FIG. 4 shows the emission spectra of further preferred embodiments of the luminescence medium.

### DETAILED DESCRIPTION OF EMBODIMENTS

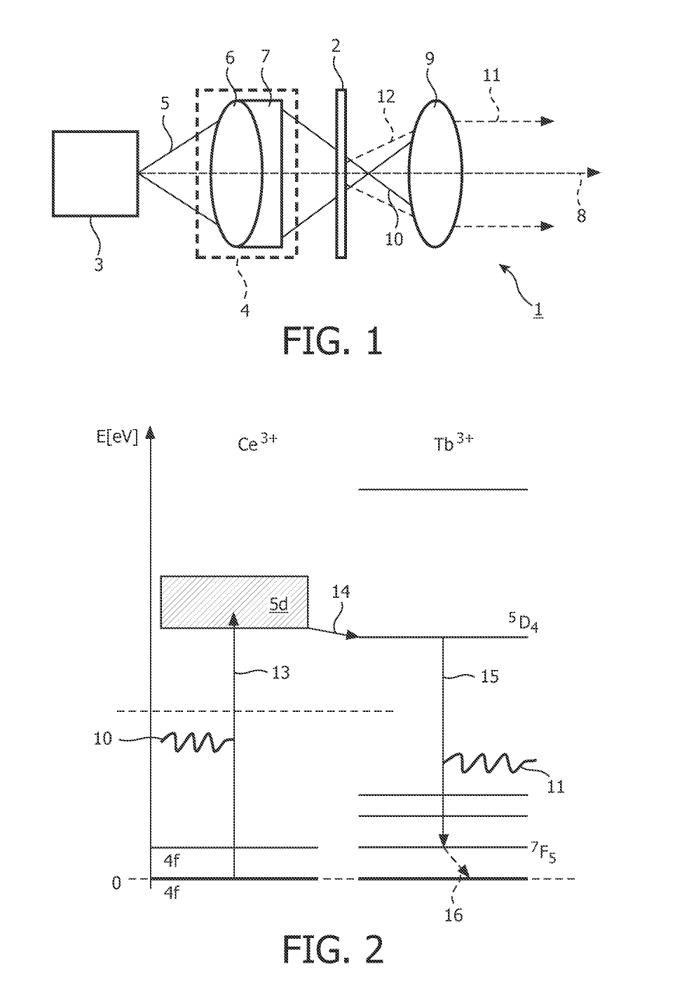

FIG. 1 shows a light-emitting device 1 comprising a wavelength converting member 2 and a light source 3 arranged to optically pump a luminescent medium of the member 2. The light source 3 is formed as a light emitting diode (LED) emitting light in a spectral wavelength region of 300 nm to 480 nm. The light-emitting device 1 further comprises an optical device 4. The wavelength converting member 2 and the optical device 4 are arranged in an optical path 5 of the light source 3, wherein the optical device 4 comprises a focusing lens 6 and a further optical element 7 for collimation and beam shaping arranged between the light source 3 and the wavelength converting member 3. The optical path 5 has a main axis 8. An additional optical element 9 is located behind the wavelength converting member 2 with respect to the light 10 (FIG. 2) emitted by the light source 3.

The wavelength converting member 2 comprises the luminescent medium, which comprises a solid state host material which is doped with rare-earth ions.

The light source 3 is emitting blue light and/or ultraviolet light 10. The blue light and/or ultraviolet light 10 emitted by the light source 3 is used for pumping the wavelength converting member 2 to create white light 11 composed of the blue light and/or ultraviolet light 10 and red and/or yellow and/or green luminescence light 12 leaving the wavelength converting member 2. The light-emitting device 1 is configured as a longitudinally pumped light-emitting device 1, wherein the resulting white light 11 is aligned to the main axis 8 of the optical path 7 of the pumping light 10.

The light emitting device 1 shown in FIG. 1 is a light emitting device emitting incoherent light. The luminescent medium of this device is a dispersive luminescent medium, preferably an opaque dispersive luminescent medium.

FIG. 2 shows an excitation scheme of one embodiment of the luminescent medium. On the left side two 4f-states 13, 14 and the lowest 5d-band 15 of Ce³⁺-ions are shown.

The luminescent medium is pumped with blue light and/or ultraviolet light 10 emitted by the light source 3. The luminescent medium absorbs the radiation of the blue light and/or ultraviolet light via the dipole allowed 4f-5d transition (arrow 13) in the Ce³⁺-ion. The excited Ce³⁺-ion transfers its energy (arrow 14) to the upper lasing state of the Tb³⁺-ion (or alternatively to the lasing state of another further rare-earth ion) which then emits the desired light 11 with a wavelength around 543 nm through a transition (arrow 14) between the upper lasing state (⁵D₄ state of the Tb³⁺) and a lower lasing state (⁷F₅ state of the Tb³⁺) followed by a transition to the ground state (arrow 16).

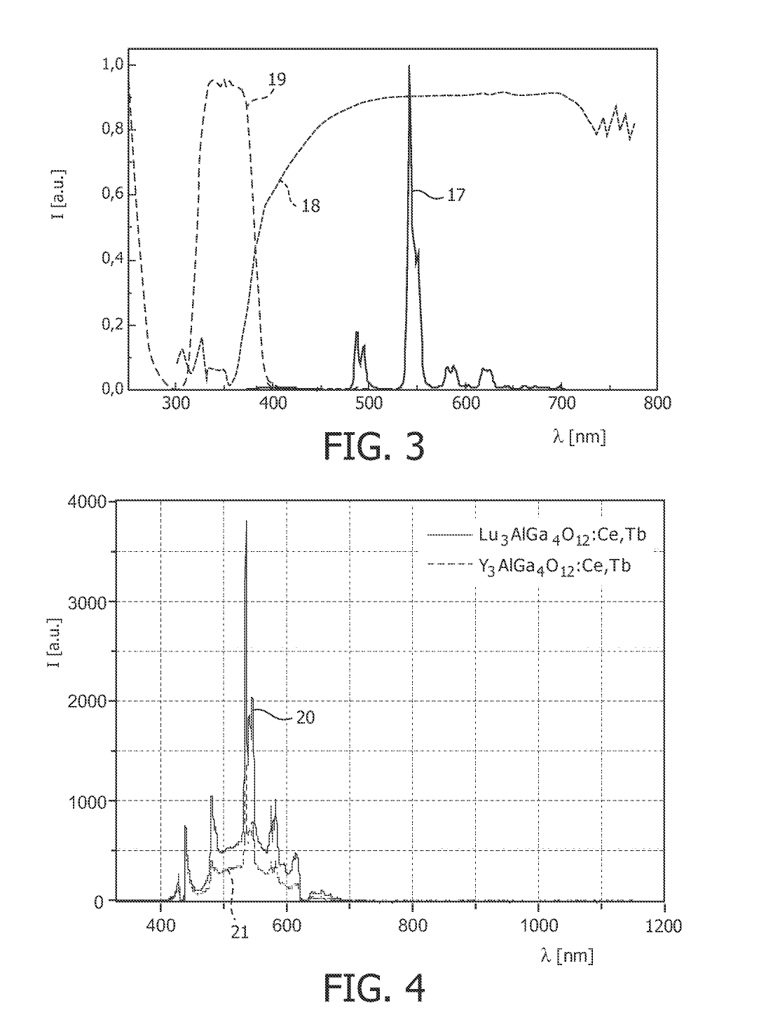

FIG. 3 shows the emission spectrum 17, excitation spectrum 18 and reflection spectrum 19 of the luminescence medium GdBO₃: Ce, Tb. This luminescence medium is a preferred embodiment of the invention for wavelength conversion of blue light and/or ultraviolet light into red light, yellow light and/or green light.

The excitation spectrum 18 shows a broad structure in the spectral wavelength range between 300 and 400 nm corresponding to the desired absorption of the radiation of the blue light and/or ultraviolet light in the spectral region of 300 nm to 480 nm via the dipole allowed 4f-5d transition (arrow 13) on the Ce³⁺-ion.

The emission spectrum 17 shows significant structures in the spectral wavelength range between 480 and 630 nm corresponding to green, yellow and red light generating a full color gamut for the human eye. The wavelength with maximum emission intensity is at λₘₐₓ=543 nm; the colour point parameter are x=0.319, y=0.610; and a high lumen equivalent LE=512 lm/W is reached.

FIG. 4 shows the emission spectra of two further preferred embodiments of the luminescence medium, the emission spectrum of Lu₃AlGa₄O₁₂:Ce,Tb 20 and the emission spectrum of Y₃AlGa₄O₁₂:Ce,Tb 21. The samples were excited with a laser diode at 442 nm, a wavelength where only Ce-ions exhibit absorption. However, the spectra are dominated by Tb-emission on a very weak Ce-background emission, which proofs that the energy transfer from Ce to Tb occurs efficiently. To suppress the strong signal from the laser diode, a notch filter at 442 nm was placed in front of the spectrometer entrance slit, which causes the structure around 442 nm in FIG. 4.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

1. Light-emitting device, comprising a wavelength converting member with a luminescent medium for wavelength conversion of blue light and/or ultraviolet light into red light and/or yellow and/or green light, and a light source emitting blue light and/or ultraviolet light arranged to pump the luminescent medium, said luminescent medium including a main phase of a solid state host material which is doped with Ce³-ions and comprises ions of a further rare-earth material Ln, wherein the host material is selected such that the emission energy of the 5d-4f emission on Ce³⁺-ions is energetically higher than the absorption energy into an upper 4fⁿ state of the further rare-earth material Ln, and wherein the light emission of wavelength converted light is caused by an intra-atomic 4fⁿ-4fⁿ transition within the ions of the further rare-earth material.

2. Light emitting device according to claim 1, wherein the ions of the further rare-earth material Ln are Pr³⁺, Sm³⁺, Tb³⁺, Dy³⁺ or a mixture thereof.

3. Light emitting device according to claim 1, wherein the luminescent medium has a dopant concentration of the Ce³⁺-ions in the range of 0.01% mol to 5% mol and a concentration of the further rare earth ions, which is between 0.5 and 50 times the dopant concentration of the Ce³⁺-ions.

4. Light emitting device according to claim 1, wherein the luminescent medium comprises (Lu_{1-a-b}CeₐLn_{b})₃(Al_{1-x-y}GaₓSc_{y})₅O₁₂, wherein 0.0≦a≦0.1; 0.0≦b≦0.6; 0.0≦x≦0.5; and 0.0≦y≦0.5.

5. Light emitting device according to claim 1, wherein the luminescent medium comprises
Ca_{1-x-y-a-b}MgₐSr_{b}(Ce_{x/2}Ln_{y/2}Na_{(x+y)/2})S, wherein 0.0≦a<1.0; 0.0≦b<1.0; and a+b<1; 0.0≦x<0.05; and 0.0≦y<0.05.

6. Light emitting device according to claim 1, wherein the luminescent medium comprises (Y_{1-x-a-b}GdₓCeₐLn_{b})₂SiO₅, wherein 0.0≦a≦0.1; 0.0≦b≦0.1; 0.0≦x≦1.0 and 0.0≦y≦1.0.

7. Light emitting device according to claim 1, wherein the luminescent medium comprises (Y_{1-a-b}CeₐLn_{b})₃(Al_{1-x-y}GaₓSc_{y})₅O₁₂, wherein 0.0≦a≦0.1; 0.0≦b≦0.6; 0.0≦x≦0.5; and 0.0≦y≦0.5.

8. Light emitting device according to claim 1, wherein the luminescent medium comprises Gd_{1-a-b}CeₐTb_{b}BO₃, wherein 0.0≦a≦0.1; 0.0≦b≦0.6.

9. Light emitting device according to claim 1, wherein the luminescent medium is a powder or a ceramic or mono crystalline material.

10. (canceled)

11. Luminescent medium for wavelength conversion of blue light and/or ultraviolet light into red light and/or yellow light and/or green light, the medium essentially having a main phase of a solid state host material which is doped with Ce³⁺-ions and comprises ions of a further rare-earth material Ln, wherein the host material is selected such that the emission energy of the 5d-4f emission on Ce³⁺-ions is energetically higher than the absorption energy into an upper 4fⁿ state of the further rare-earth material.

12. Luminescent medium according to claim 11, wherein the ions of the further rare-earth material Ln are Pr³⁺, Sm³⁺, Tb³⁺, Dy³⁺ or a mixture thereof.

13. Luminescent medium according to claim 11, wherein the luminescent medium is selected from the group consisting of:
(Lu_{1-a-b}CeₐLn_{b})₃(Al_{1-x-y}GaₓSc_{y})₅O₁₂ (0.0≦a≦0.1; 0.0≦b≦0.6; 0.0≦x≦0.5; 0.0≦y≦0.5);
Ca_{1-x-y-a-b}MgₐSr_{b}(Ce_{x/2}Ln_{y/2}Na_{(x+y)/2})S (0.0≦a<1.0; 0.0≦b<1.0; and a+b<1; 0.0≦x<0.05; 0.0≦y<0.05);
(Y_{1-x-a-b}GdₓCeₐLn_{b})₂SiO₅ (0.0≦a≦0.1; 0.0≦b≦0.1; 0.0≦x≦1.0 and 0.0≦y≦1.0);
(Y_{1-a-b}CeₐLn_{b})₃(Al_{1-x-y}GaₓSc_{y})₅O₁₂ (0.0≦a≦0.1; 0.0≦b≦0.6; 0.0≦x≦0.5; 0.0≦y≦0.5); or
Gd_{1-a-b}CeₐTb_{b}BO₃ (0.0≦a≦0.1; 0.0≦b≦0.6).

14. Luminescent medium according to claim 11, adapted for the use in a light emitting device comprising a light source arranged to pump the luminescent medium, the light source emitting blue light and/or ultraviolet light.
